(19) United States
(12) Patent Application Publication
(10) Pub. No.: US 2024/0017150 A1
(43) Pub. Date: Jan. 18, 2024

(54) SYSTEM AND METHOD OF CAPTURING AND RECORDING VIDEO CONTENT OF GOLF BALL STRIKING AND SUBSEQUENT FLIGHT

(71) Applicant: Christopher Brigdale, Ennis (IE)

(72) Inventor: Christopher Gerard Brigdale, Ennis (IE)

(21) Appl. No.: 17/865,346

(22) Filed: Jul. 14, 2022

(51) Int. Cl. A63B 71/06; A63B 57/00; A63B 57/30; A63B 69/36; H04N 5/225; H04N 5/232; H04N 5/77; H04N 7/18

(52) U.S. Cl. CPC A63B 71/0622; A63B 57/505; A63B 57/357; A63B 69/3623; H04N 5/2253; H04N 5/23206; H04N 5/77; H04N 7/183; A63B 2225/50; A63B 2220/806; A63B 2071/0647

(57) ABSTRACT

A golf flagstick-mounted system to film and record golf ball tee off and flight is provided. The system comprises a mobile device located at a tee box of a golf hole of a golf course and a wireless receiver located at the tee box area. The system also comprises a camera mounted on a flagstick of the golf hole that activates based on an instruction received from the mobile device and wirelessly determines location of the receiver. Based on determined location of the receiver, the camera captures video content of striking of golf ball from the tee box area and subsequent flight of the ball and wirelessly transmits the captured video content to the mobile device. The mobile device hosts an application that is invoked to send the instruction to the camera. The camera is mounted on a swivel arm proximate a top area of the flagstick below a flag.

### CROSS REFERENCE TO RELATED APPLICATIONS

None

### FIELD OF THE DISCLOSURE

The present disclosure is in the field of sporting goods products. More particularly, the present disclosure provides a system wherein a golfer at a tee box area uses a mobile device to send a message to a camera attached to flagstick at a corresponding hole area and wherein the camera focuses on the tee box area and records video content of the golfer striking the ball and the ball's subsequent flight with the camera then sending the recorded video content to the mobile device.

### BACKGROUND

The game of golf is hundreds of years old and enjoyed by millions of people. It is physically and mentally challenging and difficult to master. Most golfers appreciate constructive criticism and coaching as they seek to improve their game. Electronic and other tools that provide the golfer insight on his or her form while swinging a club, striking their ball, and following through on their stroke may be helpful to the user in improving his/her game.

### BRIEF DESCRIPTION OF THE DRAWING

FIG. 1 is a block diagram of a system of capturing and recording video content of golf ball striking and subsequent flight according to an embodiment of the present disclosure.

### DETAILED DESCRIPTION

Systems and methods described herein provide a camera mounted on a flagstick at a hole of a golf course, the camera directed to focus on a tee box area of the hole. The camera is configured, upon receiving an instruction, to capture video of a striking or “tee off” action of a golf ball and subsequent flight of the ball. A golfer or user preparing to strike the ball at the tee box makes an entry into a mobile device.

The camera, mounted on a flagstick, receives a message and activates based on the user entry to the mobile device entry. The camera wirelessly locates a receiver positioned at the tee box and proximate the user and his/her mobile device. As the user takes practice swings and then strikes the ball, driving the ball toward a green area and the flagstick located there, the camera captures video content of the user's actions as well as the ball's flight toward to flagstick.

The camera uses single pixel detector technology to capture the video content of the user's action as well as the ball's flight and landing on a fairway area, on the green area, in a rough area, or in a sand or water hazard. The camera then wirelessly sends the video content to the mobile device where the user can view his/her form while swinging the club as well as view the flight of the ball. The user may view the video in an effort to improve his/her form.

The mobile device in possession of the user hosts an application or app that may be provided to the user on a subscription basis. Once at the tee box area, the user invokes the app which activates the camera and begins the process described above.

The flagstick holding the camera and the tee box may be situated between approximately 210 to 250 yards from each other, about the distance of a par 3 hole. As par 3 holes are relatively short and sight lines are unobstructed between tee box and hole, systems and methods may function optimally on par 3 holes.

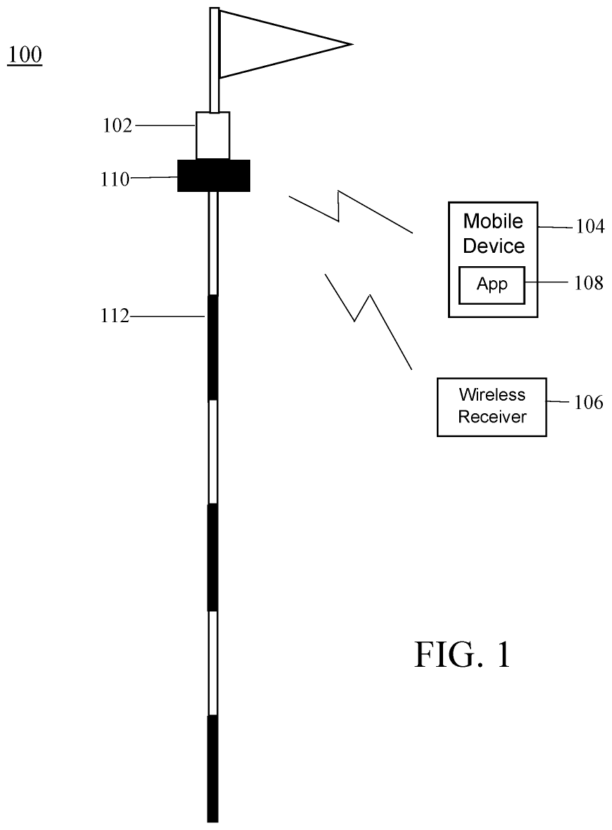

Turning to the FIGURE, FIG. 1 is a block diagram of a system 100 of capturing and recording video content of golf ball striking and subsequent flight according to an embodiment of the present disclosure. System 100 comprises a camera 102, a mobile device 104, a wireless receiver 106, an app 108, a swiveling arm 110, and a flagstick 112.

The camera 102 is attached to the swiveling arm 110 affixed to the flagstick 112. The swiveling arm 110 causes the camera 102 to turn in the direction of the tee box area where the mobile device 104 and wireless receiver 106 are situated. The app 108 executes on the mobile device 104 and is invoked by the golfer when at the tee box. The app 108 may be referred to commercially as the “holeinoneapp.” When invoked, the app 108 causes a message to be sent to the camera 102. Based on the message, the camera 102 tracks to the wireless receiver 102 to locate the tee box and focus on the golfer taking practice swings.

The camera 102 may cause the swiveling arm 110 to adjust positioning of the camera 102 based on efforts of the camera 102 to focus on the golfer as well as track the flight of the golf ball after the ball has been struck. The camera 102 may issue commands to the swiveling arm 110 that cause the swiveling arm 110 to turn the camera 102. As noted, when the ball has landed and recording of video is complete, the camera 102 sends the recorded video content to the mobile device 104.

In an embodiment, devices similar to the camera 102 and the swiveling arm 110 may be placed near the tee box such that more closeup views of the golfer may be captured of the golfer driving the ball from the tee. In an embodiment, while not shown, a remote computer may also receive the video content captured by the camera 102 that is stored and available in an event the golfer loses or destroys the mobile device 104. The remote computer may also administer a subscription program that allows golfers to access the app 108 and gain access to systems and methods provided herein.

In an embodiment, devices similar to the camera 102 may be placed near the green and supplement the output of the camera 102. Images of the ball traveling toward the green and the hole may be captured. In the unusual event that a golfer should score a hole in one, a full video may be produced of the golfer striking the ball at the tee box, the ball traveling through the air, landing, bouncing, and rolling toward the green and the hole, and ultimately falling into the hole. Such a video may be of great value to the golfer.

In an embodiment, a golf flagstick-mounted system to film and record golf ball tee off and flight is provided. The system comprises a mobile device located at a tee box area of a golf hole of a golf course and a wireless receiver located at the tee box area. The system also comprises a camera mounted on a flagstick of the golf hole that activates based on an instruction received from the mobile device and wirelessly determines location of the receiver. Based on determined location of the receiver, the camera captures video content of striking of golf ball from the tee box area and subsequent flight of the ball and wirelessly transmits the captured video content to the mobile device.

The mobile device hosts an application that is invoked to send the instruction to the camera. The camera is mounted on a swivel arm proximate a top area of the flagstick below a flag. The swivel arm enables the camera to rotate 360 degrees. The application is provided to the mobile device on a subscription basis. The camera uses single pixel detector technology to capture the video content. The camera, after locating the receiver, searches specifically for club-swinging motion by a user of the mobile device. The camera is located between 210 yards and 250 yards from the tee box.

In another embodiment, a method for recording striking and subsequent flight of golf balls on a golf course is provided. The method comprises a mobile device located at a tee box area of a hole of a golf course receiving an entry to activate an application. The method also comprises the mobile device, via the activated application, transmitting a wireless command to a camera mounted on a flagstick for the hole. The method also comprises the mobile device, after a golf ball has been struck at the tee box, receiving at least one message, the message containing video content depicting the ball being struck and depicting subsequent flight of the ball.

The method further comprises the mobile device receiving the at least one message from the camera, the camera having commenced capture of the video content upon receiving the wireless command. The method further comprises the mobile device at the tee box receiving positioning proximate a wireless receiver, the receiver aiding the camera in focusing on the tee box area and flight of the ball. The method further comprises the camera using single pixel detector technology to capture the video content. The method further comprises the mobile device receiving access to the application on a subscription basis. The method further comprises the mobile device receiving positioning between 210 yards and 250 yards from the camera.

In yet another embodiment, a method for recording video content of a striking of a golf ball and subsequent flight of the ball is provided. The method comprises a camera mounted on a golf flagstick positioned at a hole of a golf course activating based receipt of a wireless message. The method further comprises the camera locating a wireless receiver situated at tee box area of the hole. The method further comprises the camera locating a golf ball situated at the tee box area based on determined location of the wireless receiver. The method further comprises the camera capturing video content of a striking of the golf ball and subsequent flight of the golf ball. The method further comprises the camera transmitting the video content to at least a mobile device.

The method further comprises the camera receiving the wireless message from the mobile device. The method further comprises the camera using single pixel detector technology to capture the video content. The mobile device is located at the tee box area, the mobile device issuing the wireless message. The method further comprises the camera, after determining location of the receiver and prior to capturing the video content, searching specifically for golf club-swinging motion by a user of the mobile device. The method further comprises the camera receiving the wireless message based on invocation of a subscription-based application executing on the mobile device.

What is claimed is:

1. A golf flagstick-mounted system to film and record golf ball tee off and flight, comprising:
a mobile device located at a tee box area of a golf hole of a golf course;
a wireless receiver located at the tee box area; and
a camera mounted on a flagstick of the golf hole that:
activates based on an instruction received from the mobile device,
wirelessly determines location of the receiver,
based on determined location of the receiver, captures video content of striking of golf ball from the tee box area and subsequent flight of the ball, and
wirelessly transmits the captured video content to the mobile device.

2. The system of claim 1, wherein the mobile device hosts an application that is invoked to send the instruction to the camera.

3. The system of claim 1, wherein the camera is mounted on a swivel arm proximate a top area of the flagstick below a flag.

4. The system of claim 3, wherein the swivel arm enables the camera to rotate 360 degrees.

5. The system of claim 2, wherein the application is provided to the mobile device on a subscription basis.

6. The system of claim 1, wherein the camera uses single pixel detector technology to capture the video content.

7. The system of claim 1, wherein the camera, after locating the receiver, searches specifically for club-swinging motion by a user of the mobile device.

8. The system of claim 1, wherein the camera is located between about 210 yards and 250 yards from the tee box.

9. A method for recording striking and subsequent flight of golf balls on a golf course, comprising:
a mobile device located at a tee box area of a hole of a golf course receiving an entry to activate an application;
the mobile device, via the activated application, transmitting a wireless command to a camera mounted on a flagstick for the hole;
the mobile device, after a golf ball has been struck at the tee box, receiving at least one message, the message containing video content depicting the ball being struck and depicting subsequent flight of the ball.

10. The method of claim 9, further comprising the mobile device receiving the at least one message from the camera, the camera having commenced capture of the video content upon receiving the wireless command.

11. The method of claim 10, further comprising the mobile device at the tee box receiving positioning proximate a wireless receiver, the receiver aiding the camera in focusing on the tee box area and flight of the ball.

12. The method of claim 10, further comprising the camera using single pixel detector technology to capture the video content.

13. The method of claim 9, further comprising the mobile device receiving access to the application on a subscription basis.

14. The method of claim 9, further comprising the mobile device receiving positioning between about 210 yards and 250 yards from the camera.

15. A method for recording video content of a striking of a golf ball and subsequent flight of the ball, comprising:
a camera mounted on a golf flagstick positioned at a hole of a golf course activating based receipt of a wireless message;
the camera locating a wireless receiver situated at tee box area of the hole;
the camera locating a golf ball situated at the tee box area based on determined location of the wireless receiver;
the camera capturing video content of a striking of the golf ball and subsequent flight of the golf ball; and
the camera transmitting the video content to at least a mobile device.

16. The method of claim 15, further comprising the camera receiving the wireless message from the mobile device.

17. The method of claim 15, further comprising the camera using single pixel detector technology to capture the video content.

18. The method of claim 15, wherein the mobile device is located at the tee box area, the mobile device issuing the wireless message.

19. The method of claim 15, further comprising the camera, after determining location of the receiver and prior to capturing the video content, searching specifically for golf club-swinging motion by a user of the mobile device.

20. The method of claim 16, further comprising the camera receiving the wireless message based on invocation of a subscription-based application executing on the mobile device.
